(19) United States
(12) Patent Application Publication
(10) Pub. No.: US 2010/0161288 A1
(43) Pub. Date: Jun. 24, 2010

(54) INTERACTIVE SYSTEM FOR A ROOM DESIGN

(75) Inventor: WILLIAM R. THOMAS, STEVENSVILLE, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/341,374

(22) Filed: Dec. 22, 2008

(51) Int. Cl. G06F 17/50

(52) U.S. Cl. 703/1

(57) ABSTRACT

A computerized system and a method for interactively designing a room within a home. The system has a processor, a data storage device, a set of computer readable instructions and a user interface with a visual display for receiving design inputs and displaying design inquiries and outputs. The invention displays the design inquiries on the user interface, with at least one of the design inquiries regarding a location of the room in the home, receives from the user interface design inputs responsive to the design inquiries, determines design requirements for the room based on the design inputs, determines a room design for the room based on the design requirements, including populating the room design with at least one appliance based on the room location, and displays a graphical representation of the room design on the user interface.

### BACKGROUND OF THE INVENTION

During a purchase, construction or remodeling of commercial and/or residential interior spaces, a selection of appliances, finishing, materials, colors, functionality and, more importantly, coordination thereof can be a difficult and time consuming task and often does not yield the desired results.

Numerous websites and computer software provide computer-based room design, relying on computer software alone or computer-assisted design mediated by human designers. The stand alone software programs generally run on personal computers and have limited design manipulation abilities or set to design a room element by element using a method of trial and error. Many potential users do not have a professional designer skills and/or knowledge required to work with advanced computer-assisted design software.

For a better result, an interior designer may assist customers with the selection and coordination of interior design, including furniture, floor and wall treatments, appliances, etc. for commercial and/or residential interior spaces. The designer generally designs the space based on aesthetic, functional and/or budgetary perspectives.

To select furnishings, a designer generally examines the space, discusses the functional, aesthetic and/or budgetary preferences and requirements with the customer, and designs different floor plans and selects different furnishing combinations that may satisfy the conditions and constraints of the space and the customer. To assist in the design, the designer may use sample books of furnishings or view furnishings offered by retail or wholesale establishments. The designer reduces the vast number of furnishings to a practical number of styles and patterns thought appropriate. The designer and customer together narrow the remaining options to a practical few. A sample of each product or product type may be mounted on a foam-backed board, known as a “colorboard”, so that the customer can view the proposed furnishings and the manner in which they coordinate in the particular space. The customer, with or without the assistance of the designer, selects and purchases desired furnishings. The purchased furnishings are positioned into the space in accordance with the design selected.

The professional designers come with a fee. Many potential customers are either unwilling or unable to pay the costs accompanying a designer, although many of them still need or wish they could obtain design assistance.

### SUMMARY OF THE INVENTION

A computerized system and a method for interactively designing a room within a home are disclosed. The system has a processor, a data storage device in electronic communication with the processor, a user interface with a visual display in electronic communication with the processor for receiving design inputs and displaying design inquiries and design outputs, a set of computer readable instructions residing on the data storage device and controlling the processor. According to the method of operation, the present invention displays the design inquiries on the user interface, with at least one of the design inquiries regarding a location of the room in the home, receives from the user interface design inputs responsive to the design inquiries, determines design requirements for the room based on the design inputs, determines a room design for the room based on the design requirements, including populating the room design with at least one appliance based on the room location, and displays a graphical representation of the room design on the user interface.

### BRIEF DESCRIPTION OF THE DRAWINGS

In the drawings:

FIG. 1 is an exemplary embodiment of the invention in a store environment.

FIG. 2 is a schematic illustration of components of the interactive computerized system used in the invention.

FIGS. 3-8 are examples of design inquiries displayed on the visual display of the computerized system of FIG. 2.

FIG. 9 is an example of graphical representations generated on the visual display by the computerized system of FIG. 2.

FIG. 10 is an example of graphical representations on the visual display of the user's current room and a selected new room solution.

FIG. 11 is an exemplary presentation of the information about displayed room elements of the selected new room solution of FIG. 10.

FIG. 12 is a flow chart of one embodiment of a method of operation.

### DESCRIPTION OF AN EMBODIMENT OF THE INVENTION

A system for interactive room design and a method of designing a room according to the invention are provided to enable a quick, guided makeover of a current user's house space into a functional and aesthetically pleasing new space. A new space designed using the system and according to the method is hereinafter referred to as a new room. The house space may be any room or any interior section of a commercial or residential building.

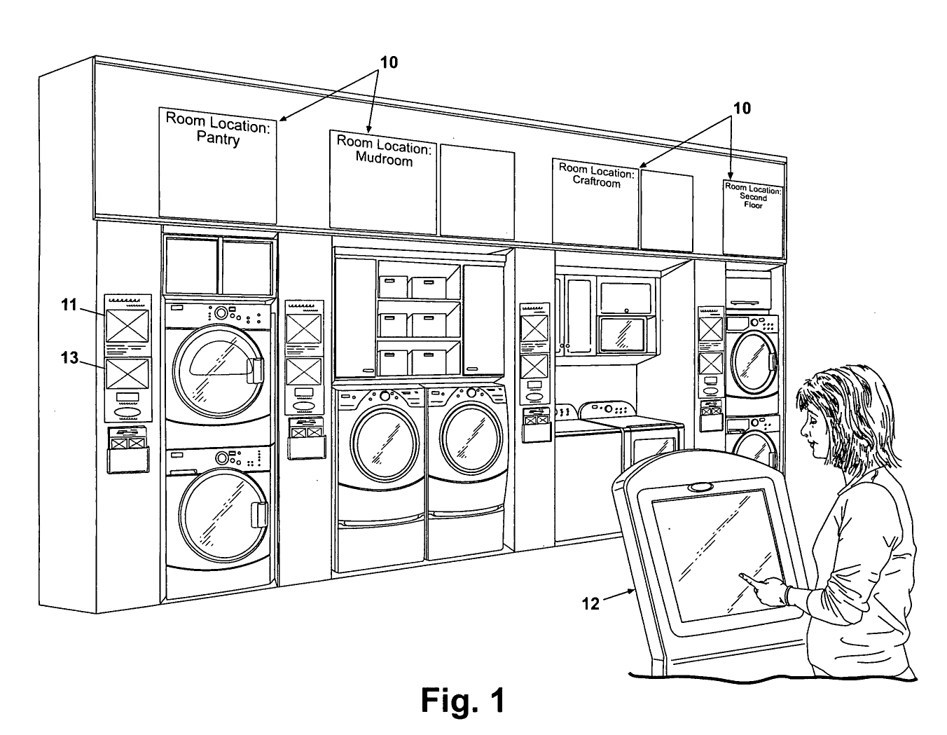

FIG. 1 illustrates one exemplary embodiment of the invention having one or more vignettes 10 and an interactive computerized system 12 in a store environment. Each vignette 10 is real size model of a new room designed by the present invention and demonstrated in the store to provide a visual effect and “feel” to a potential user. Each vignette 10 may be accompanied with a picture of the original space 11, i.e. the space before the makeover, and a picture of the new room after the makeover 13. The computerized system 12 according to the illustrated embodiment is a touch screen kiosk located in a store or anywhere accessible by potential users.

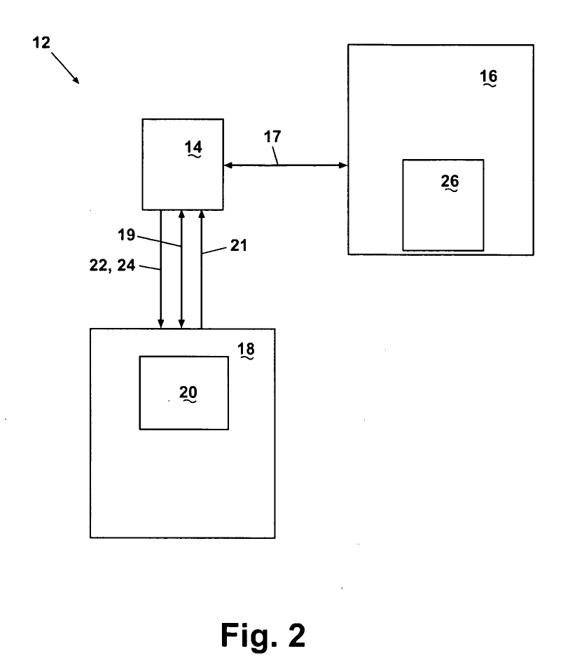

Referring now to FIG. 2, the interactive computerized system 12 comprises a processor 14, a data storage device 16 in electronic communication with the processor 14 as noted at 17, and a user interface 18 with a visual display 20 in electronic communication with the processor 14 as noted at 19. A set of computer readable instructions 26 resides on the data storage device 16 to control the processor 14. The user interface 18 displays design inquiries 22 generated by the processor 14 and receives design inputs 21 from a user, which are communicated to the processor 14. The processor 14 generates design outputs 24 based on the design inputs 21, and which are displayed on the visual display 20.

The visual display 20 can be any output device for presenting information for visual reception. Some non-limiting examples include a computer monitor, a touch screen, a television screen, a projector screen, and a visual display on an electronic device such as a Blackberry, a PDA, a GPS receiver, a cellular phone, etc. The electronic communications 17 and 19 can be enabled via a cable or wireless connection (Wi-Fi, internet, etc. All components of the computerized system 12 can be incorporated into a stand alone device (such as a kiosk) or located remotely with the user interface 18 assessable by a user.

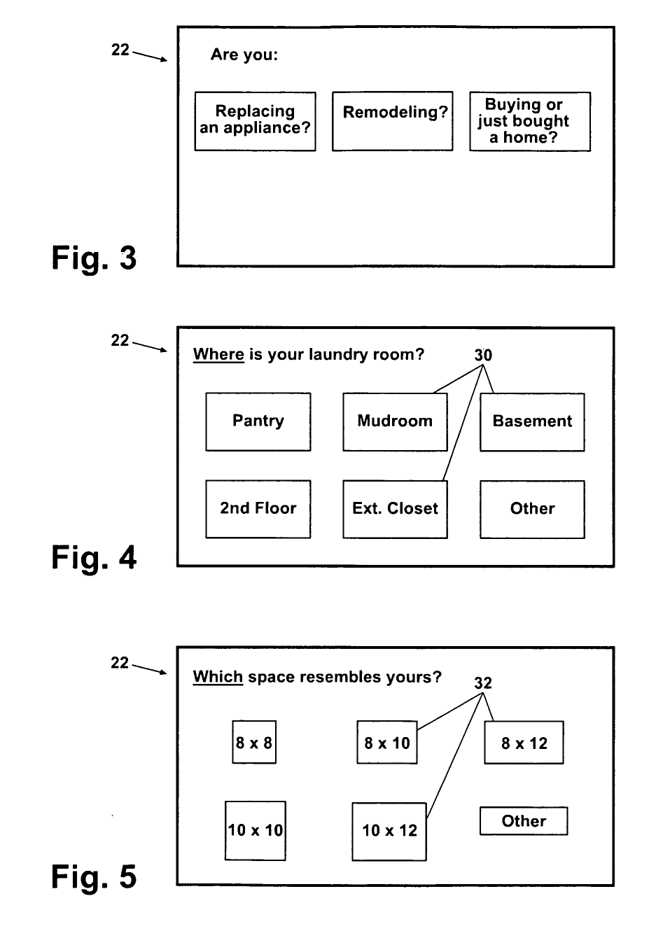

Referring in general to FIG. 3-9, there is illustrated a visual display 20 with examples of design inquiries 22 displayed thereon. The design inquiries 22 can be in a form of a set of questions presented for selection or in a form of a question with a predetermined set of answers. A guided questionnaire with a predetermined set of available selections for each inquiry can be used for the design inquiries 22 of the present invention, with at least one design inquiry regarding the location of the room in the home. The design inquiries can be presented to a user as interactive images on the visual display 20. Each image is available for a selection by a user and can hold prompting text under the image. In response to the prompts, a user can touch the visual display 20 ‘here’, if the display is touch screen for example, or click ‘here’, if not, depending on the particular implementation of the computerized system 12. One or more design requirements can be determined based on the user input for each of the design inquiries 22.

Referring in particular to FIG. 3, an initial set of design inquiries begins with images having the questions: “Are you replacing?”, or “Are you remodeling?”, or “Buying or just bought a home?” FIG. 4 illustrates an exemplary design inquiry regarding the location of the room in the home. The illustrated inquiry is in a form of a question: “Where is your laundry room?” with a subset of room location categories 30 available for selection. The subset of room location categories 30 are pre-selected from a domain of all possible room locations based on commonality of the room locations within a building. In an alternative embodiment all possible room location categories can be displayed for selection by the user. Some non-limiting examples of room location categories 30 include Pantry, Mudroom, Basement, Second Floor, Extended Closet and Other. Selection of the category ‘Other’ may bring another subset of possible room locations having less commonality among room locations. Some non-limited examples of other possible room locations include Garage and Under the Stairs.

Further inquires for the design requirements 22 can be directed to identify and generate a graphical representation of a room resembling the user's current room, hereinafter referred to as the user's current room. Those inquires may have a question: “Which space resembles yours?” as illustrated in FIG. 5. The available predetermined set of answers 32 can depend on the inquiry regarding the location of the room in the home. The subset of answers is preselected from the domain of possible room sizes based on commonality of the typical room sizes. Non-limiting examples of the room sizes subset include 8×8, 8×10, 8×12, 10×10, 10×12 and Other. Selection of the category ‘Other’ may bring another subset of possible room sizes and/or rooms of irregular shapes.

Next, one or more design inquiries related to the user's current appliances can be presented to the user on the visual display 20. Type, brand, model and arrangement of the user's current appliances are examples of the appliance related design inquiry.

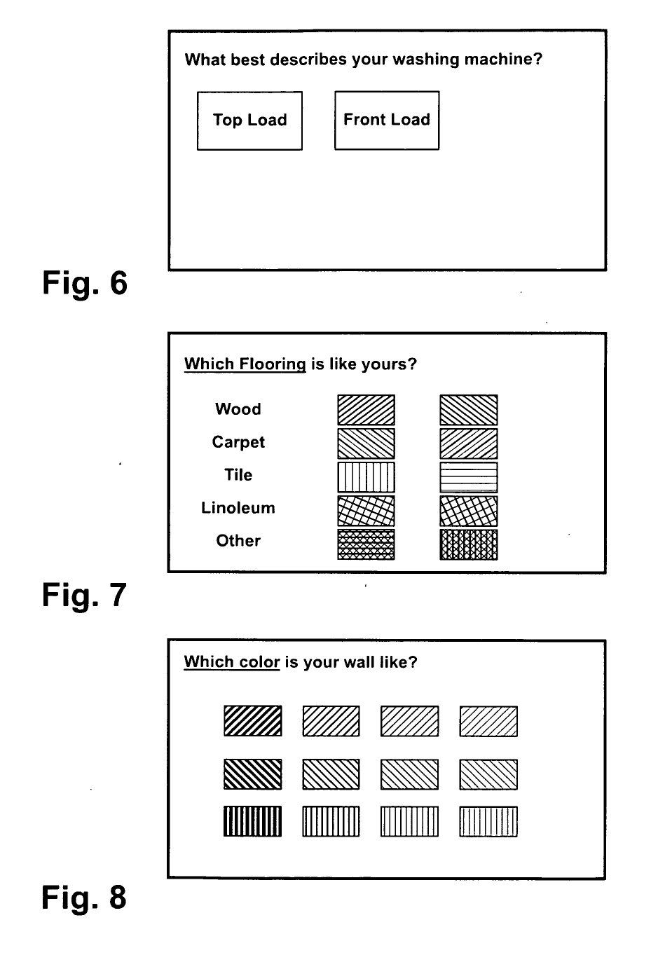

FIG. 6 illustrates an example of the user's current appliance inquiry in a laundry room environment. Here, the inquiry asks about the type of washing machine. The laundry room appliance arrangements can be in a form of options such as ‘side-by-side’, ‘stackable’, ‘stacked combo’, or in the form of a question “Which laundry pair resembles yours?” with a set of images available for a selection by the user.

Other appliances and corresponding appliance type, brand, model and arrangement questions can be presented to the user based on the room function and location. Some non-limiting examples of other appliances are a refrigerator, an oven, a microwave oven, a dishwasher and a wine cooler.

Also, design inquiries may can questions about floor type and/or color and wall color as shown in FIGS. 7 and 8, along with a preselected set of types and colors available as the user's input for those inquiries.

It will be understood, that the design inquiries 22 are not limited to the inquiries shown in FIGS. 3-8. Other inquiries related to a user's current room can be presented to the user, as well as other inquiries to determine the user's profile, and aesthetic and budget preferences.

Based on the user's response to the inquiries, i.e., the user's input 21 including a response to the room location inquiry, the design requirements for the user's room are determined by the computerized system 12. The design requirements can be a room template, a household appliance parameter, and/or an accessory parameter. The room template is a preselected subset of room templates from a domain of all room templates, where the preselected subset is based on the user's input for the room location inquiry. Each room template can be displayed with room props specific to the room location and populated with one or more appliances. Typically, the room props will likely be different for the user's current and new rooms. For example, the props for the user's current room may be a clutter and disorganization of displayed room elements, and the props for the new room may have an organized arrangement of the displayed new room elements.

The determined household appliance parameter is selected from a type of the household appliance, a number of the appliances, and/or an arrangement of the appliances. The type of the appliance can include appliance dimensions, brand of the appliance, model of the appliance, and/or technical characteristics of the appliance.

The determined accessory parameter is selected from a type of the accessory, a number of accessories, and/or an arrangement of the accessories. The type of accessory may be an appliance accessory and/or an environmental accessory. The appliance accessory may be any appliance related element suitable for populating the displayed room. Some non-limiting examples of the appliance accessory include an appliance pedestal, a work surface, an ironing station, laundry sorting, a laundry hanging system, bulk dispensing, a sink, a laundry tower, and an appliance color. The environmental accessory may be any functional or esthetic room element also suitable for populating the displayed room. Some non-limiting examples of the environmental accessory include cabinetry, furnishings, a storage organizer, a type of flooring, a color of flooring, wall color, garbage and recycling collection, lighting, refrigeration, entertainment, pet care, power outlet, and supply.

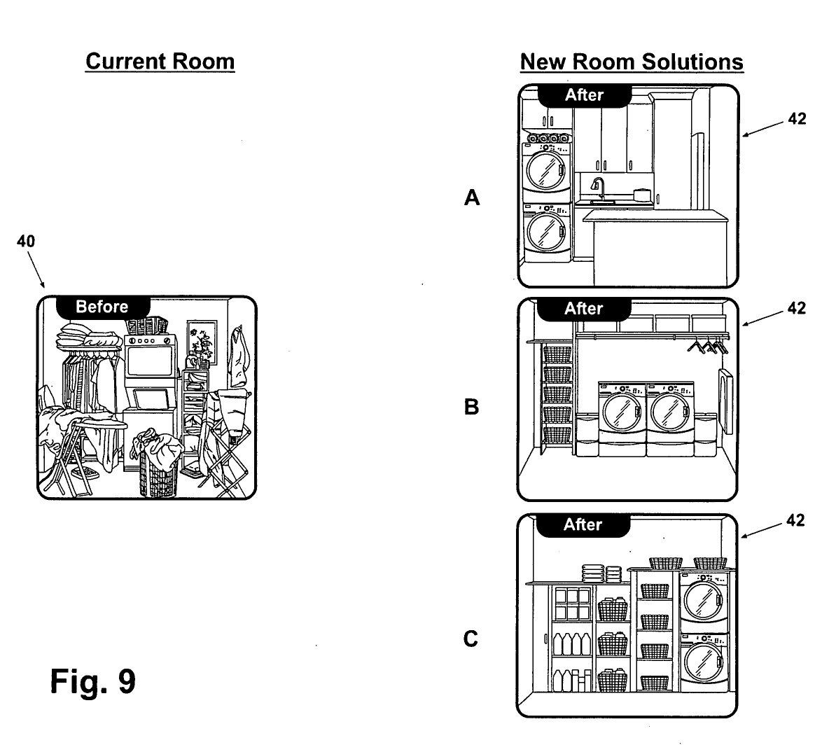

Turning now to FIG. 9, there is illustrated a graphical representation of an exemplary room design output 24 from the processor 12 and displayed on the user interface 18. The generated graphical representation may have a graphical representation of the user's current room 40, one or more new rooms 42 or a combination thereof. FIG. 9 shows one exemplary embodiment of the invention, which simultaneously displays the user's current room 40 and multiple new rooms 42, with the new rooms 42 varying relative to each other. Ranking criteria can be implemented for displaying the order of multiple new rooms 42. The criteria can be based on the appliance parameter, the accessory parameter, the user's budget, and/or other user preferences. The criteria may be predetermined in the computer readable instructions 26 or may be provided by the user's input 21.

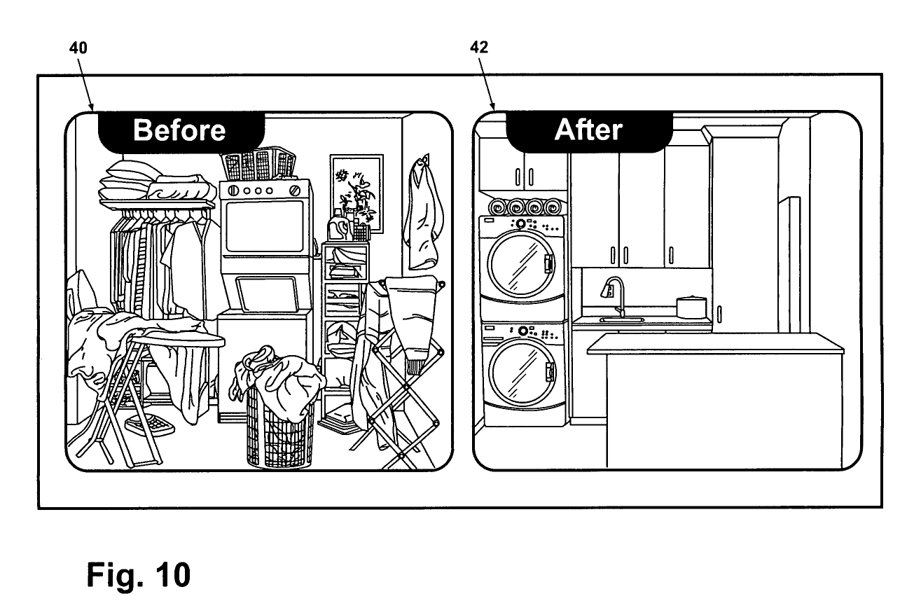

Upon selection by the user of any one of the generated new rooms 42, larger images of the current room 40 and the selected new room 42 can be displayed as demonstrated by FIG. 10. Displaying simultaneously the graphical representations of the user current room 40 and a selected new room 42 enables the user to compare the user's room before and after the makeover.

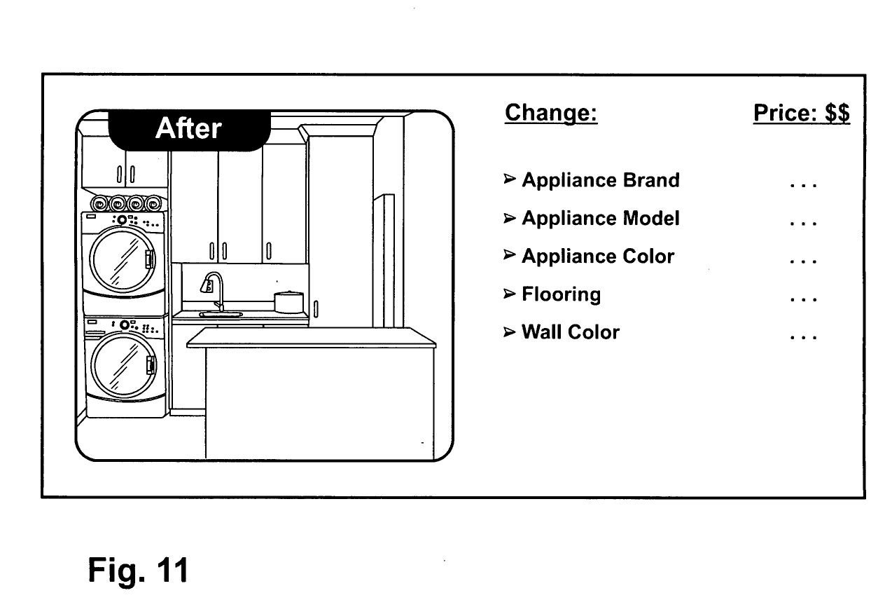

The information about each displayed room element of the selected new room 42 can be presented in a form of the product listing as shown in FIG. 11. Alternatively or in addition, the information about each displayed room element can be in the form of a context popup as the user touches the screen or causes a cursor to hover over a room element of the selected new room 42 in FIG. 10.

Optionally, the selected new room 42 with displayed room elements can be further customized by the user. For example, the user may change or customize the household appliance, the accessory parameter, or both. The customization can be aesthetical such as change of colors, functional such as change of appliances, or a combination thereof. Additionally, the customization may be directed to adjust the budget for all or any selected room elements of the selected new room 42.

During any stage of interacting with the computerized system 12, all user input data and the generated graphical representations of the user's current room, multiple new rooms and further customized new room can be saved in the data storage device 16 or in a remote server enabling the user to have an access to the saved information via internet or in-store kiosk at a later date. A username and a password may be created to allow a returning user to access the saved data. The computerized system 12 will also preferably enable a user to purchase all or any combination of the customized displayed room elements of the selected new room 42.

While a laundry room is demonstrated here in the exemplary figures and design inquiries, it will be understood that the invention is applicable and may be used for interactive makeover of any space.

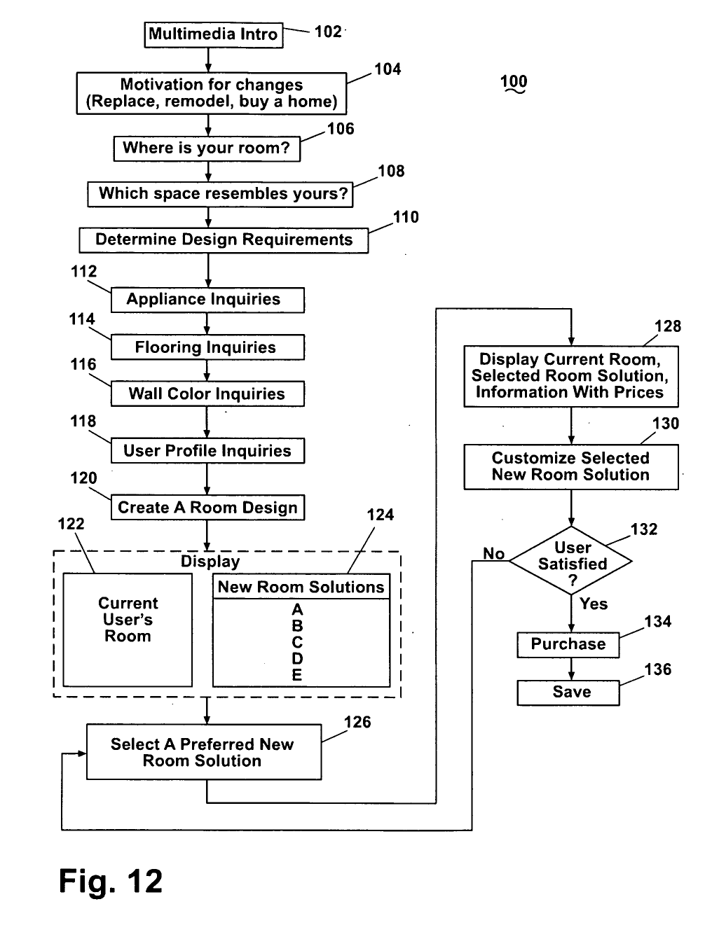

In operation, demonstrated by the flow chart in FIG. 12, the process 100 according to the invention, including the user interaction with the computerized system 12 can begin with a multimedia presentation 102 of a purpose and benefits of the present invention, prompting a user to begin interaction with the visual display 20. Upon user engagement, the design inquiries 104-108 are displayed, usually sequentially, on the user interface, where the inquiry 106 concerns the location of the room in the space. The optional inquiry 104 may influence the subset of the room location categories of step 106, based on geographic or other factors. The current room inquiry 108 can be based on the user input in the step 106. The design requirements are determined at 110 based on all user inputs 104-108 including the room location inquiry 106.

Optional inquiries 112-116 made to a user via the user interface 18 can further modify the design requirements as they clarify and further identify the user's current room. Inquiry 112 asks about the user's current appliances, if any. Inquiry 114 asks about floor type and color. Inquiry 116 asks about wall color. Additional inquiries may be made to the user about user's current room, along with inquiries to determine the user's aesthetic, functional and budget preferences shown by an optional step 118. After step 116, further refining may be made to the design requirements determined at 110.

Based on the design requirements 110 and optionally on steps 112-118, the system 12 creates a room design at 120 and populates the room design with at least one appliance and generated props based on the room location. The inquiries 112-118 are optional and may be omitted, for example, where a user is buying or building a new space as opposed to remodeling an existing space. In such case, the step 110 of determining the design requirements will be followed immediately by the step 120 of creating a room design.

The computerized system 12 displays the graphical representation of the user's current room 122 and one or more new rooms 124 (new room solutions). In case of the multiple graphical representations of the new room, the user is enabled to choose a preferred new room solution at step 126. The user's current room 122 and the preferred new room solution can be simultaneously shown at 128 on the visual display 20 (see, e.g., FIG. 10), as well as the information about each displayed element of the selected new room solution (see, e.g., FIG. 11).

An optional step 130 enables the user to further customize the selected graphical representations of the new room solution. Appliance, accessory and budget parameters can be changed at this step.

If the user decides at a step 132 that design solution demonstrated by the selected and optionally further customized graphical representation of the new room is satisfactory, he or she can purchase all or some of the new room displayed elements at the step 134. The information and the price about each displayed element can still be readily available to assist the user with the decision making.

If the user decides at a step 132 that design solution is not satisfactory, he or she can choose a different graphical representation of the new room at the step 126 and will have an option to further customize newly chosen design solution at 130.

All user input data, the generated graphical representations of the user's current room, multiple new rooms and the further customized graphical representation of new room can be saved at a step 136 enabling the user to have an access to the saved information at a later date. It will be understood that the saving step 136 need not be limited to occurring after the purchase step 134. The data can also be saved at any step on the path for later reuse. Also, a username and a password can be created at the beginning of the user interaction in step 102 or at the step 134 to secure the data.

Thus, according to the present invention, a few guided steps enable a user to compare the user's current cluttered and disorganized room with multiple room solutions for the user's space, identify a preferred room solution, further customize it and purchase the desired appliances and accessories demonstrated by the customized room solution.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A computerized system for designing a room within a home, the computerized system comprising:
a processor;
a data storage device in electronic communication with the processor;
a user interface with a visual display in electronic communication with the processor for receiving design inputs and displaying design inquiries and design outputs;
a set of computer readable instructions residing on the data storage device and controlling the processor for:
displaying design inquiries on the user interface, with at least one of the design inquiries regarding a location of the room in the home,
receiving from the user interface design inputs responsive to the design inquiries, with at least one of the design inputs corresponding to the location of the room in the home,
determining design requirements for the room based on the design inputs,
determining a room design for the room based on the design requirements, including populating the room design with at least one appliance based on the room location, and
displaying a graphical representation of the room design on the user interface.

2. The computerized system of claim 1 wherein displaying design inquiries comprises displaying room location categories on the visual display for selection by a user.

3. The computerized system of claim 2 wherein displaying design inquiries comprises displaying predetermined room sizes, for selection by the user, corresponding to the selected room location category.

4. The computerized system of claim 3 wherein determining a room design comprises determining a room design for at least one of a current room and a new room.

5. The computerized system of claim 4 wherein displaying the graphical representation comprises simultaneously displaying a graphical representation of the current room and the new room.

6. The computerized system of claim 5 wherein determining a room design for the new room comprises determining multiple variants of the room design for the new room, and the displaying a graphical representation of the room design comprises displaying a graphical representation for the multiple variants.

7. The computerized system of claim 4 wherein generating a graphical representation of the current room comprises displaying props based on the selected room location category.

8. The computerized system of claim 2 wherein displaying room location categories comprises displaying a subset of room location categories from the domain of possible room location categories.

9. The computerized system of claim 8 wherein the subset of room locations is selected based on the commonality of the room location.

10. The computerized system of claim 8 wherein the subset of room locations comprises at least one of a pantry, a mudroom, a basement, a second floor, an extended closet and a garage.

11. The computerized system of claim 1 wherein displaying design inquiries further comprises displaying at least one of a room template, a household appliance parameter and an accessory parameter.

12. The computerized system of claim 1 in combination with at least one room vignette.

13. A method of interactively generating a graphical representation of a room design for a room within a home, the method comprising:
displaying design inquiries on a user interface for selection by a user, with at least one of the design inquiries regarding the location of the room in the home;
receiving from the user interface design inputs responsive to the design inquiries, with at least one of the design inputs corresponding to the location of the room in the home;
determining design requirements from the design inputs;
creating a room design for the room based on the design requirements, including populating the room design with at least one appliance based on the room location;
generating a graphical representation of the room design, and
displaying on a graphical display the graphical representation.

14. The method of claim 13 wherein displaying design inquiries comprises displaying room location categories.

15. The method of claim 14 wherein displaying room location categories comprises displaying a subset of room location categories from the domain of possible room location categories.

16. The method of claim 15 wherein the subset of room locations is selected based on the commonality of the room location.

17. The method of claim 15 wherein the subset of room locations comprises at least one of a pantry, a mudroom, a basement, a second floor, an extended closet and a garage.

18. The method of claim 13 wherein displaying design inquiries comprises displaying predetermined room sizes, for selection by the user, corresponding to the selected room location category.

19. The method of claim 13 wherein creating a room design comprises creating a room design for at least one of a current room and a new room.

20. The method of claim 19 wherein displaying the graphical representation comprises simultaneously displaying a graphical representation of the current room and the new room.

21. The method of claim 13 wherein creating a room design comprises generating multiple variants of the room design, generating a graphical representation of the room design comprises generating a graphical representation for the multiple variants, and displaying a graphical representation of the room design comprises displaying the graphical representation for the multiple variants.

22. The method of claim 13 wherein generating a graphical representation comprises displaying props based on the room location.

23. The method of claim 13 wherein displaying design inquiries further comprises displaying at least one of a room template, a household appliance parameter and an accessory parameter.

24. The method of claim 13 in combination with at least one room vignette.
